(19) United States
(12) Patent Application Publication
(10) Pub. No.: US 2025/0178795 A1
(43) Pub. Date: Jun. 5, 2025

(54) Reusable Candle Jar System

(71) Applicant: Tracey Lynch, Indianapolis, IN (US)

(72) Inventor: Tracey Lynch, Indianapolis, IN (US)

(21) Appl. No.: 18/526,752

(22) Filed: Dec. 1, 2023

(51) Int. Cl. B65D 43/02; B65D 1/10; C11C 5/00; F21V 35/00

(52) U.S. Cl. CPC B65D 43/0202; B65D 1/10; C11C 5/008; F21V 35/00; B65D 2251/0018; B65D 2251/0081; B65D 2543/00092

(57) ABSTRACT

A reusable candle jar wherein the candle jar separates from the bamboo base, using one of three methods. A bamboo spatula is included to remove any wax residue. Then the specially fitted and formed wax form refill is inserted into the base, the glass jar is reattached, and the candle is ready to burn with zero glass waste.

### BACKGROUND OF THE INVENTION

Making glass requires sand. Not just any sand though, only a specific type of sand can be used. Currently, we are using sand (50 billion tons a year) to make glass at a faster rate than the earth can replenish it.

Sand is harvested from riverbeds and seabeds, disrupting the ecosystems from which they are taken from. This can lead to increased risk of flooding and erosion in those areas.

Transportation is a big part of the production process. First the sand must be collected and transported somewhere for it to be inspected. After it is inspected and melted in about 1700° C. heat, it is transported somewhere else to be conditioned, formed, and finished.

Then the product must be transported elsewhere in order to be washed and sterilized, before being transported again for sales use. All of this transportation releases greenhouse gas emissions. Because glass is a heavier and more delicate material than plastic, it costs more to transport and requires extra transportation compared with the same amount of plastic.

The entire glass-making process uses up a lot of raw materials, time, energy, and resources. The estimated carbon footprint of one 500 ml glass bottle is equal to 503 g of carbon dioxide. It creates even more emissions from transportation, as well as the fossil fuels that are burned in order to heat up the furnaces that the sand is melted in.

Traditionally, candle jars have closed, sealed bottoms and are made out of 1 piece of glass with the bottom of the jar fused to the sides. There is no convenient way to refill the jar with the original scent that accompanied the jar. So, unless a jar can be repurposed, has sentimental value, or is extremely decorative, consumers throw the jar away and repurchase a new jar candle.

### SUMMARY OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The present subject matter is a reusable candle jar system, which means consumers only need to buy the refill, reducing waste and promoting sustainability. Candles are housed in a luxurious glass jar and come in several fragrances.

The reusable candle jar system significantly reduces glass and packaging waste, is a lighter product so the packaging weight reduces emissions to ship, and consumers get to keep the beautiful jars they hate to part with.

The present matter comprises of a circular outer glass container 5 with an opening on the top 10, and opening on the bottom 15, a removably coupled bamboo top 20, and a twist off bottom 25, specially shaped candles 30, and a wax scraping spatula 35. In some embodiments the top and bottom may be made from other materials such as ceramic, glass, wood, steel, cork, or any other suitable material.

After a candle has been used as desired by the consumer, the twist off bottom is removed, and the wax scraping spatula is able to easily dislodge the candle and remove any candle residue from the jar. A new specially shaped candle is inserted into the reusable candle jar, the bottom is screwed on, and then the top is placed on top of the jar for later use.

In some embodiments, the bottom of the jar has a D-clip to secure the bottom of the jar. In other embodiments, the bottom of the jar uses a twist and lock system. In further embodiments, the bottom of the jar uses a suction closure system wherein silicone bands secure the bottom portion to the jar.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### DESCRIPTION OF DRAWINGS

FIG. 1 shows a perspective view of the reusable candle jar system wherein the jar is empty, and the lid is still on the jar.

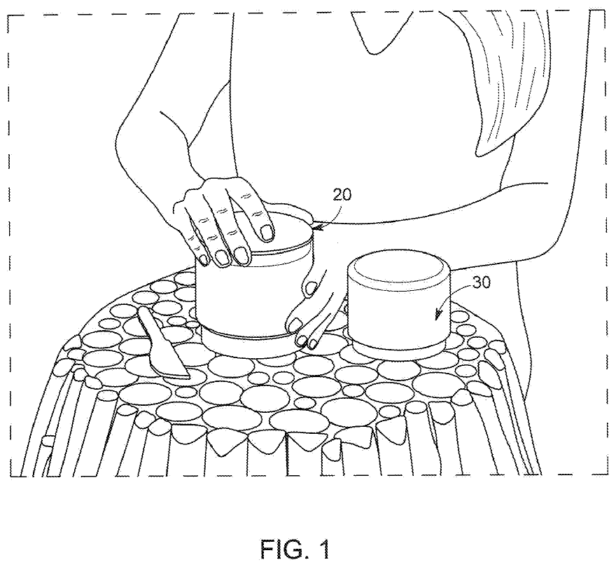

FIG. 2 shows a perspective view of the reusable candle jar system wherein the jar is empty, and the lid is removed from the jar.

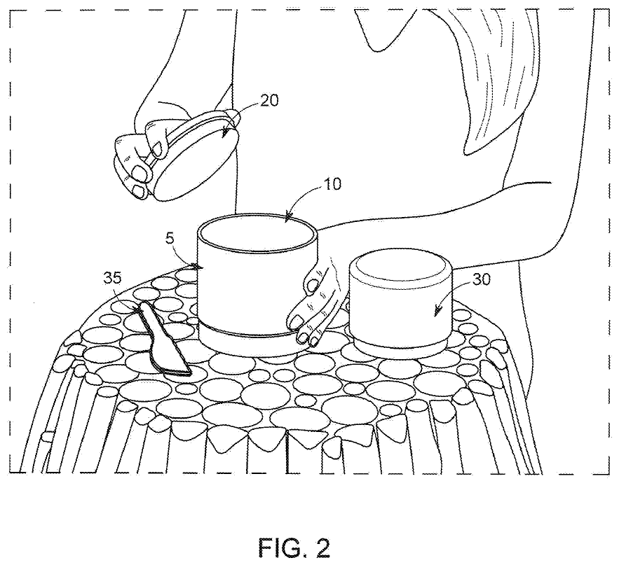

FIG. 3 shows a perspective view of the reusable candle jar system wherein the jar is empty, and the twist off bottom is still attached to the jar.

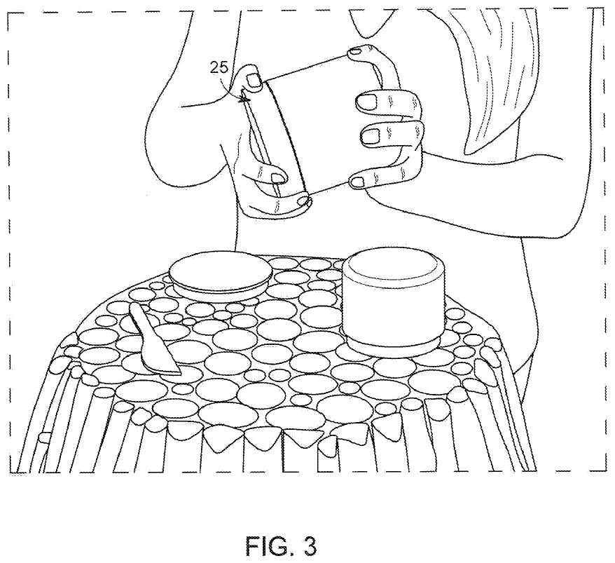

FIG. 4 shows a perspective view of the reusable candle jar system wherein the jar is empty, and the twist off bottom is removed from the jar.

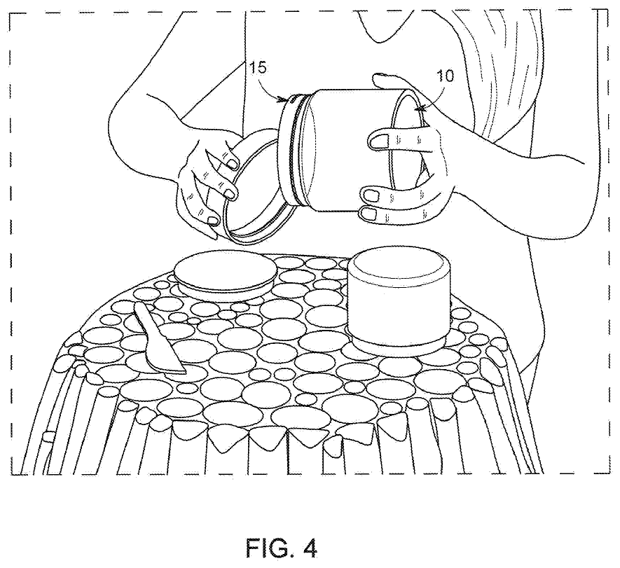

FIG. 5 shows a perspective view of the reusable candle jar system wherein the candle is specially shaped with ridges to accommodate the bottom opening.

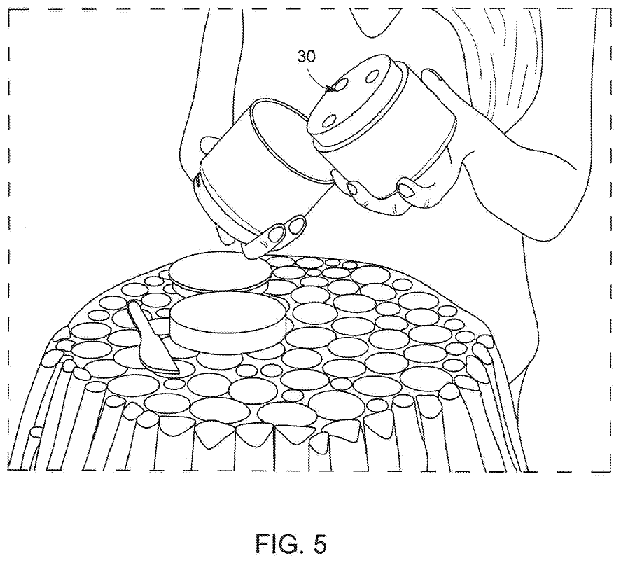

FIG. 6 shows a perspective view of the reusable candle jar system wherein the specially shaped candle is inserted into the jar.

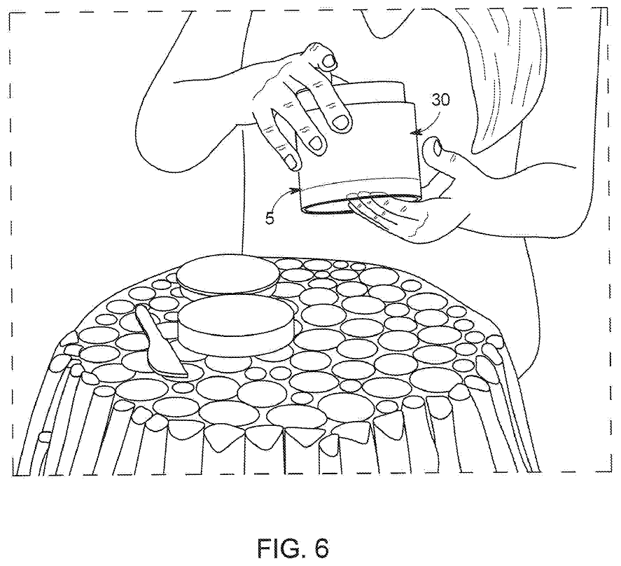

FIG. 7 shows a perspective view of the reusable candle jar system wherein the bottom is being twisted back onto the jar.

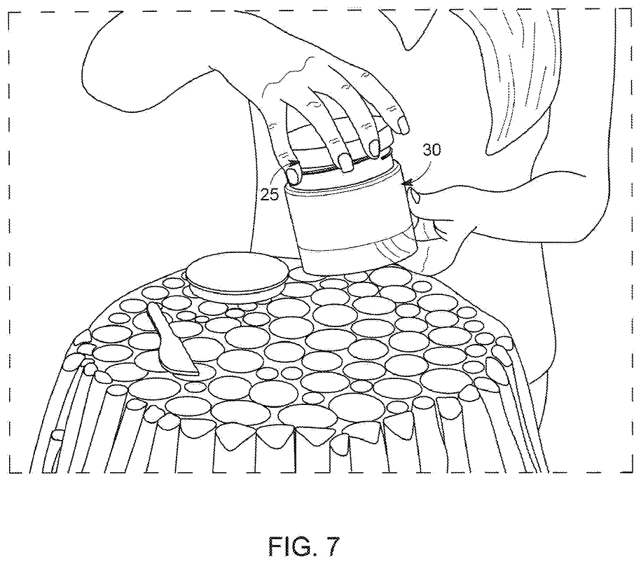

FIG. 8 shows a perspective view of the reusable candle jar system wherein the candle is ready for use.

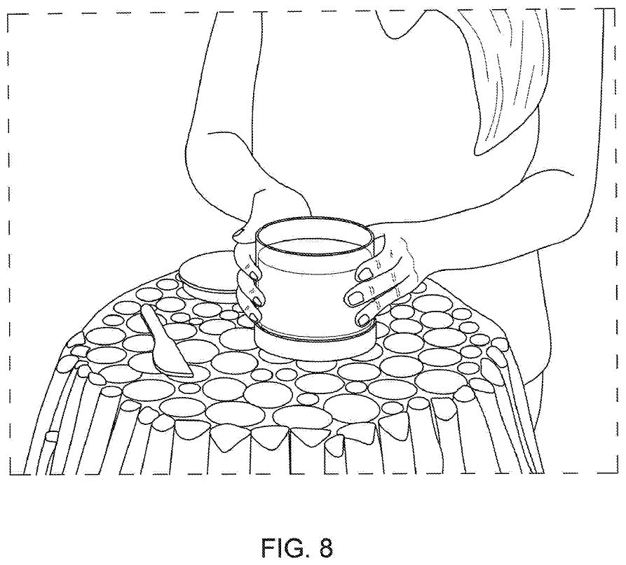

1. A reusable candle jar system comprising of an outer glass container, a removably coupled bamboo top, a twist off bottom, specially shaped candles, and a wax scraping spatula.

2. The reusable candle jar system comprising of the outer glass container, the removably coupled bamboo top, the twist off bottom, specially shaped candles, and the wax scraping spatula as in claim 1, wherein the outer glass container has an opening at the top and bottom.

3. The reusable candle jar system comprising of the outer glass container, the removably coupled bamboo top, the twist off bottom, specially shaped candles, and the wax scraping spatula as in claim 1, wherein the twist off bottom allows for the wax scraping spatula to easily dislodge the candle and remove any residue.

4. The reusable candle jar system comprising of the outer glass container, the removably coupled bamboo top, the twist off bottom, specially shaped candles, and the wax scraping spatula as in claim 1, wherein the specially shaped candle has ridges to accommodate the bottom opening of the jar.

5. The manufacturing of a reusable candle jar system comprising of an outer glass container, a removably coupled bamboo top, a twist off bottom, specially shaped candles, and a wax scraping spatula.

6. The manufacturing of the reusable candle jar system comprising of the outer glass container, the removably coupled bamboo top, the twist off bottom, specially shaped candles, and the wax scraping spatula as in claim 5, wherein the outer glass container has an opening at the top and bottom.

7. The manufacturing of the reusable candle jar system comprising of the outer glass container, the removably coupled bamboo top, the twist off bottom, specially shaped candles, and the wax scraping spatula as in claim 5, wherein the twist off bottom allows for the wax scraping spatula to easily dislodge the candle and remove any residue.

8. The manufacturing of the reusable candle jar system comprising of the outer glass container, the removably coupled bamboo top, the twist off bottom, specially shaped candles, and the wax scraping spatula as in claim 5, wherein the specially shaped candle has ridges to accommodate the bottom opening of the jar.
